(19) United States
(12) Patent Application Publication
(10) Pub. No.: US 2024/0413769 A1
(43) Pub. Date: Dec. 12, 2024

(54) Process and Apparatus for the Production of Electric Power Avoiding Environmental Wasting

(71) Applicant: Adriana Brizio, AGRA-Collina d’Oro (CH)

(72) Inventor: Adriana Brizio, AGRA-Collina d’Oro (CH)

(21) Appl. No.: 18/698,164

(22) PCT Filed: Oct. 4, 2021
(86) PCT No.: PCT/EP2021/077238

§ 371 Date: Apr. 3, 2024

(51) Int. Cl. H02N 11/00; H01F 7/02; H01F 7/20

(52) U.S. Cl. CPC H02N 11/002; H01F 7/02; H01F 7/20

(57) ABSTRACT

The invention describes an apparatus for generating electric power including a sealed assembly including at least two chambers, a communication duct connecting the two chambers, at least one energy conversion device and a working medium contained in at least one of the chambers. The apparatus is configured to transform energy of the working medium travelling through the communication duct into electric power.

### CROSS REFERENCE TO RELATED APPLICATION

This application is the United States national phase of International Patent Application No. PCT/EP2021/077238 filed Oct. 4, 2021, the disclosure of which is hereby incorporated by reference in its entirety.

### BACKGROUND OF THE INVENTION

### Field of the Invention

The invention relates to an apparatus and process for generation of electric power avoiding environmental wasting.

### Description of Related Art

Most of the current systems for the production of electricity are nowadays provoking incommensurable damages to the health of planet, as they are causing pollution and/or overheating of the atmosphere, are using sources subjected to consumption until their possible exhaustion or, even worse, are resorting to the use of nuclear energy.

The reserves of fossil fuels such as coal, oil and natural gas are limited and non-renewable moreover, their combustion contributes to global warming. The generation in turn of energy through deforestation generates an increase in the greenhouse effect, while water is not everywhere available for powering hydroelectric plants.

The nuclear source presents serious risks when it is not perfectly managed and controlled. Moreover, it gives rise to serious and still unresolved problems connected to the disposal of radioactive waste. Moreover, the current technology relies on uranium which is a limited source.

The technologies for producing energy from renewable sources, including solar panels, photovoltaic panels or wind turbines, have the disadvantage of aleatory output mostly related to the possible absence of light, sun and wind. Besides, they have the non-negligible drawback of visual pollution because of the large aboveground surfaces that must be used for the installation of the photovoltaic, solar panels and because of the large size and considerable height of the wind turbines.

### SUMMARY OF THE INVENTION

The present invention aims to a process and apparatus for generation of electric power which obviates the above-described drawbacks of the prior art.

The present invention aims to provide a process which does not generate any of the afore described problems, particularly no heating of the planet, no pollution, no deforestation, no dependence on coal, oil, water or uranium, no dependence on sun and wind presence. Besides, the invention aims to a process which can be performed in an underground structure to avoid visual pollution.

Moreover, the invention aims to provide a process which does not cause any leakage of water or other kind of liquids into the environment.

These aims are reached with an apparatus and process according to the claims.

An apparatus for generation of electric power according to the invention comprises:
a sealed assembly including at least two chambers and a communication duct, wherein the communication duct is arranged to provide fluid communication between said two chambers;
a working medium in a liquid state contained in at least one of said chambers;
wherein a vacuum condition is provided in the assembly, so that the boiling temperature of said liquid working medium in the assembly is lower than the boiling temperature of the same liquid at ambient pressure;
wherein the volume of said liquid working medium is less than the inner capacity of the whole assembly;
wherein the apparatus is configured in such a way that heating the liquid working medium contained in a first chamber of the assembly induces a transfer of the working medium, either in liquid state or in a vapor state, from said first chamber to a second chamber of the assembly, through a communication duct between said first chamber and second chamber;
the apparatus further comprising at least one energy conversion device arranged in at least one chamber and/or in the communication duct and configured to transform the energy of the working medium travelling through the apparatus into an electric power output,
wherein said energy conversion device includes at least one magnetic element which is arranged to enter into direct contact with the working medium.

The invention is based on the finding of collecting and transforming the energy of the working medium travelling through the assembly from one chamber to a next chamber. The working medium, initially contained in a first chamber, is induced to travel to a next second chamber by means of heating the first chamber.

The working medium travels from one chamber to another in a liquid state or in a vapor state preferably without a phase transition, more preferably in a liquid state.

The passage of the working medium from a generic first chamber to a second chamber may be induced by the pressure of vapor formed in the first chamber, as a result of heating. Accordingly, the pressure will push the liquid away from the first chamber and towards the second chamber via a communication duct between them.

To facilitate the above process, the assembly is kept under vacuum, so that a relatively small input of heat is sufficient to vaporize the liquid medium in the first chamber and to establish a pressure which will expel the liquid away from the chamber, through the communication duct and into the second chamber. A similar principle can be observed in the so-called Franklin's Thermoscope. The invention uses this principle to produce energy by exploiting the energy contained in the working medium, preferably liquid, displaced from one chamber to another.

One feature of the invention is the use of an energy conversion device including at least one magnetic element. Said at least one magnetic element enters into a direct contact with the working medium while the working medium is transferred from a chamber to another. The apparatus of the invention may include one or more magnetic elements arranged to rotate and/or translate under the thrust of the working medium. The rotation or translation of the magnetic element(s) is converted into electric power by a suitable coil or solenoid. As explained below, the interaction between magnetic elements and coils/solenoids allows to collect the energy from the working medium contained in a sealed environment.

### DETAILED DESCRIPTION OF THE INVENTION

The assembly, particularly the working medium circuit, is maintained under vacuum. The higher is the vacuum degree produced in a closed chamber, the lower is the temperature at which a liquid contained in the same chamber starts its boiling process. The invention makes use of this principle to reduce the heat input required to vaporize the working medium.

The working medium may be a pure liquid or a liquid mixture and has preferably a boiling point lower than the boiling point of water. For instance, ethyl alcohol or liquid ether can be used as working medium.

The appropriate vacuum degree and the kind of the adopted liquid may be selected depending on the environmental conditions of any apparatus, that is the altitude and/or the outside ambient temperature.

The number of chambers and communication ducts in the assembly may vary. A simple embodiment is possible with two chambers and one communication duct between them. Other embodiments may include a greater number of chambers and/or of communication ducts between the chambers. Particularly, each pair of chambers may be connected by one or more communication ducts. In some embodiments, two adjoining chambers may be collected by a single duct. In other embodiments, adjoining chambers may be connected by two or more ducts. When multiple connection ducts are provided, one or more ducts may act as return ducts to provide a continuous circulation of the working medium.

In an embodiment, the assembly is configured so that one or more of the communication ducts act as connecting elements and/or structural supporting elements for two or more of the chambers.

In an embodiment, the assembly is configured so that the working medium effluent from a first chamber through a communication duct returns in the same first chamber either through the same communication duct or through a separate communication duct.

The assembly may include more than two chambers forming a sequence of chambers, wherein the working medium is transferred through the chambers. Each transfer can be regarded as a transfer of the working medium from a first chamber or starting chamber to a second chamber or destination chamber, next to the first chamber in the sequence, the transfer of the working medium being operated as a result of heating the starting chamber.

In an interesting embodiment of the invention, the sequence of chambers forms a closed circuit and the process is performed cyclically while the working medium traverses the closed-circuit sequence of chambers. Hence for example a working medium may start the process from a first chamber and after passages through several chambers in the assembly, may return into the same first chamber.

In some embodiments, suitable barriers are provided in connection with the chambers and/or with the communication ducts, said barriers being driven to prevent a backflow of the working medium from one chamber to a preceding chamber. Hence it is provided that the working medium follows the proper direction from a starting chamber through a destination chamber in the assembly.

The energy conversion device of the assembly may comprise rotating and/or displaceable magnetic elements. A rotating magnetic element is an element arranged to rotate around an axis. A displaceable magnetic element is arranged to travel through the assembly, for example between the chambers and through the connection ducts. The energy conversion device may include any combination of rotating and displaceable elements.

The energy conversion device of the assembly further includes at least one coil or solenoid inductively coupled with a magnetic element, arranged so that a rotation or displacement of the magnetic element relative to the coil or solenoid induces an electric current in the coil or solenoid.

In an embodiment, said energy conversion device includes at least a rotating magnetic element, said rotating magnetic element being arranged to rotate under the thrust of said working medium when said working medium is displaced from one chamber to another chamber. A preferred, but not exclusive, shape of said rotating magnetic element/elements consists in a helix shape.

Said rotating magnetic element(s) may be supported by a rotating bar or by a stationary bar, said bar being preferably inside a communication duct. More preferably, the axis of said bar is parallel to a longitudinal axis of said communication duct. In case of a rotating bar, the rotating magnetic elements may be fixed to the bar, so that the assembly of the rotating bar and magnetic elements form a rotating screw. In case of a fixed bar, the rotating magnetic elements may rotate around the bar, for example being mounted on suitable bearings.

In an embodiment, the apparatus includes a plurality of rotating bars to support rotating magnetic elements and at least one first rotating bar is connected to one or more second rotating bar(s) in such a way to increase the rotational speed of said one or more second rotating bar(s). The rotating bars may be connected by suitable transmission means to increase the rotational speed.

Said energy conversion device may include at least one coil or solenoid inductively coupled with the rotating magnetic element, so that a rotation of the rotating magnetic element, and therefore a rotation of its magnetic poles, induces an electric current in the coil or solenoid.

Particularly preferably, a coil or solenoid may be located in a position adjacent and preferably wrapped onto an enclosure within which the rotating magnetic element is disposed to rotate. Alternatively, a coil or solenoid constitute itself an enclosure within which said rotating magnetic element is disposed to rotate. For example, a coil may structurally constitute a communication duct between two chambers.

In some embodiments, the energy conversion device includes at least one displaceable magnet arranged to be displaced by the working medium from one chamber to another through a communication duct. Preferably the apparatus includes at least one device, preferably in the form of a grid casing, arranged in a chamber to guide said displaceable magnet when travelling through the chamber and prevent said magnet from falling into the chamber. Preferably a suitable grid casing is provided in each chamber of the apparatus.

According to necessity, some or all portions of the assembly of the invention may be differently wrapped. One or more of said portion or portions may be wrapped by one or more solenoid or solenoids, or by coils and solenoids together, while some of said portions are formed by the afore described coils and/or solenoid or solenoids themselves, as well as some of said portions may be without any wrapping.

The displaceable magnets may travel separately in the apparatus or be joined together to form a single displaceable element, possibly with suitable spacers between them.

Particularly preferably, the displaceable magnets are arranged so that, when travelling through the device, each pole of a magnet faces a pole of a preceding or following magnet of the same polarity.

Said energy conversion device may include at least one coil or solenoid and at least one magnetic element arranged to rotate or move relative to the coil or solenoid, thus providing a variable magnetic field in the coil or solenoid and an induced electromotive force.

In an embodiment, said magnetic elements include permanent magnets.

Said communication duct(s) is/are made preferably of an electrically conductive metal.

An embodiment includes at least one communication duct wherein a coil or solenoid is wrapped around the duct or a coil or solenoid constitutes the communication duct.

An embodiment includes a plurality of coils or solenoids, wherein at least some of the coils or solenoids are electrically connected to each other.

The invention is now further elucidated with reference to various embodiments of the same.

In the various embodiments, the communication ducts may be in the form of a tube. Said tube puts into communication the cavities of said opposite chambers, said tube being of proper length and diameter.

The whole ensemble is liquid and gas sealed.

A liquid is inserted into the aforesaid ensemble before sealing and is preferably gathered into a first chamber. The volume of the liquid will be less than the whole inside volume of the ensemble in such a size that the liquid can freely flow within the afore described communication tube from one chamber to another chamber in communication with the first one.

A proper vacuum degree is provided inside said ensemble before sealing, to such an extent that a minimal heating energy is requested to force said liquid to start its boiling process, consequently to find an escape route from the aforesaid first chamber through the afore described communication tube. Particularly, the heat input is lower than the heat input necessary to induce boiling at the ordinary ambient conditions outside the assembly of the invention.

Both providing a vacuum degree, and selecting a liquid having a boiling point lower than the water boiling point, may be conveniently adopted in combination.

After matching the above-described conditions, heating is applied to the liquid which is collected into a first chamber, to such an extent as to induce the same liquid to start boiling.

Having provided, as above described, a duct in the form of a tube departing from said first chamber and putting into communication said first chamber with an opposite communicating one, said liquid finds its escape route through said tube duct to collect into the opposite communicating chamber.

Depending on the position of the afore described tube duct in the respect of the afore described chambers, said liquid may found its escape maintaining its liquid consistency, or said liquid assumes under heating a vapor consistency and it becomes liquid again, due to condensation, once collected in an opposite chamber.

In a preferred embodiment the afore described communication tube duct is positioned in a lower portion of the chambers wall in such a way that, in consequence of heating, said liquid displaces from a first chamber to a following one while keeping its liquid state.

Once the aforesaid liquid has collected into an opposite communicating chamber through the afore described communication tube duct, heating can be again applied to said liquid to such an extent that it is forced to find a further escape from said opposite communicating chamber. In this way, by applying the heating consecutively to one chamber and to a communicating one, a consecutive displacement of said liquid is originated.

In an embodiment, an assembly is composed by two opposite chambers and is structured in such a way that the liquid, when subjected again to heating after having collected into the afore described opposite communicating chamber, has no further escape but going back to collect into the aforesaid first chamber. A return connection tube duct may be provided to this purpose.

The afore described coil/coils and/or said solenoid/solenoids may be located in a position adjacent and preferably wrapped onto the portion or portions of the aforesaid assembly within which the rotating magnetic element/elements is/are induced to rotate. In such a case said portion/portions will be conveniently made of a conductive metal.

Alternatively, said coil/coils and/or said solenoid or solenoids themselves are shaped, twisted and positioned in such an intimate, reciprocal closeness as to constitute themselves part of the ensemble portion within which said magnetic element or elements is/are induced to rotate.

In the event that the aforesaid chambers and tube ducts constitute a closed circuit, the induced electricity may be accumulated from any coil or coils and/or solenoid/solenoids to give place to a final output quantity.

In an embodiment with displaceable magnets and only two opposite chambers communicating by means of a communication tube duct, the magnet or magnets is/are induced to assume an alternative movement departing from the first chamber to the second chamber and back to said first chamber. In such a case, the induced electricity which is generated inside the coil/coils or solenoid/solenoids will be an alternating current.

In an embodiment, the afore described magnetic element/elements departing from one of the afore described chambers, enters/enter the following communicating chamber by leaving the communication tube duct. This allows to avoid generation of a magnetic field inside said tube duct, according to Lenz's law, which would oppose the entry of a next magnetic element. In this way a flow of permanent magnets can be performed in sequence, so as to ensure a constant induced electric charge in the coil/coils or solenoid/solenoids.

With regard to both the adoption of rotating magnetic elements and of flowing magnetic elements, the higher the speed of movement of said movable magnetic element/elements and the higher the number of spires forming the coil/coils and or in the solenoid/solenoids, the greater will be the quantity of induced electricity.

It should be noted that, once the initial chamber has been heated by means of external sources, the energy necessary to heat the subsequent chambers is much lower than the energy initially used, since the working medium that moves from one chamber to another loses only a small degree of heat.

Moreover, the apparatus is able of partially self-feeding by employing part of the final electric energy, outgoing from the same, in order to repeat from the beginning the heating of the same apparatus chambers.

Conveniently the heating degree, at which both the rotating magnetic elements and the flowing magnetic elements will be subjected, shall not be higher than the temperature degree at which said elements lose their magnetic charge. In any case it is advisable that the temperature degree will not reach the Curie Point relative to said magnetic elements.

Should said elements lose their magnetic charge, owing to a special case or to deterioration of the plants due to age, said elements will be subjected to a re-magnetization process, resorting to known means.

### BRIEF DESCRIPTION OF THE DRAWINGS

FIG. 1 is a schematic representation of an apparatus for generating electric power according to an embodiment of the invention with a dual-chamber configuration.

FIG. 2 is a schematic representation of the apparatus for generating electric power of FIG. 1 according to an embodiment of the invention with a closed-circuit configuration.

FIG. 3 is a schematic representation of an apparatus for generating electric power according to an embodiment of the invention with a multiple-chambers configuration.

FIG. 4 is a schematic representation of an apparatus for generating electric power according to an embodiment of the invention with a closed-circuit configuration and according to a multiple-chambers configuration.

FIG. 5 in the embodiments a) to c) represents a series of apparatus for generating electric power according to the configurations of FIGS. 1, 3 and 4 additionally provided with solenoids.

FIG. 6 shows a detail view of an apparatus for generating electric power according to an embodiment of the invention.

FIG. 7 shows a detail view of an apparatus for generating electric power according to an alternative embodiment of the invention.

### DESCRIPTION OF THE INVENTION

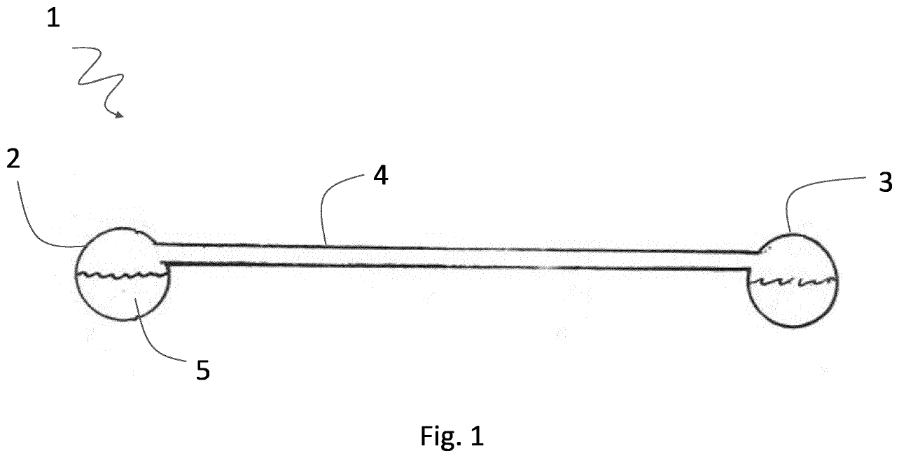

In the embodiment of FIG. 1, it is shown that the apparatus for generating electric power includes a sealed assembly 1 including a first chamber 2 and a second chamber 3 communicating between each other by means of a duct 4. It can be noted that the communication duct is in the form of a tube and a working liquid 5 is enclosed in said first chamber 2.

The apparatus works by providing heat to said working medium so to promote a transfer of said working medium 5 from said first chamber 2 to said second chamber 3 via said communication duct 4 meanwhile transforming the energy of the working medium into electric power by means of an energy conversion device not shown in the figure, which may be arranged for example along the duct 4. Once the liquid 5 is collected in the second chamber 3, said second chamber 3 may be heated to transfer the liquid 5 back into the first chamber 2. The process can be repeated cyclically.

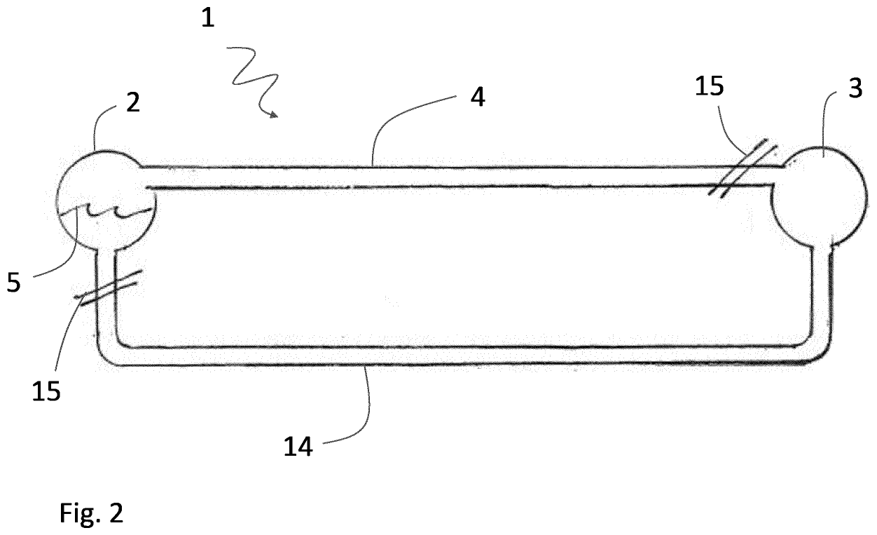

FIG. 2 shows that the first chamber 2 of the apparatus is in fluid communication with the second chamber 3 by means of the above-mentioned communicating duct 4 and by means of a separate return duct 14.

The assembly 1 is also provided with two barriers 15 in connection with the communication duct 4 and with the return duct 14. Said barriers 15 are arranged to prevent the backflow of the working medium 5 from one chamber to the preceding one.

According to the embodiment of FIG. 2, the first chamber 2 is heated to transfer the working medium 5 to the second chamber 3 meanwhile generating electric power. Afterwards, the second chamber 3 is heated to transfer the working medium 5 back into the first chamber 2 via the return duct 14. The process can be repeated cyclically thereby obtaining a continuous production of electric power.

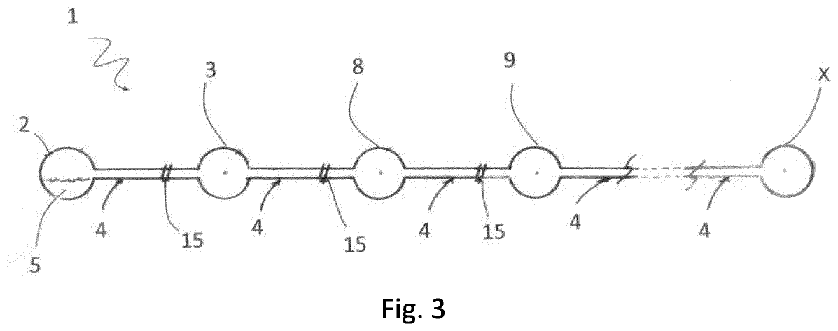

In FIG. 3, it is shown an apparatus for generating electric power provided with multiple chambers 2, 3, 8 and 9. Each chamber is separated from another chamber through a communication duct 4. Each communication duct 4 is provided with a barrier 15 to prevent the backflow of liquid. The last portion of tube 4 indicates the possibility of adopting an indefinite additional number of chambers, until a last chamber denoted by X in the figure, provided that the whole ensemble is sealed.

In this embodiment, heating is applied in sequence first to the first chamber 2 to drive the working fluid 5 to the second chamber 3 meanwhile generating electric power. Afterwards, the process is repeated in sequence by providing heat to the second chamber 3 to transfer the working fluid 5 to a third chamber 8 meanwhile generating electric power. The process is repeated again in sequence with the remaining chamber 9 and possible following ones. As in FIG. 1, the liquid 5 can be transferred back by heating the chambers in the appropriate sequence.

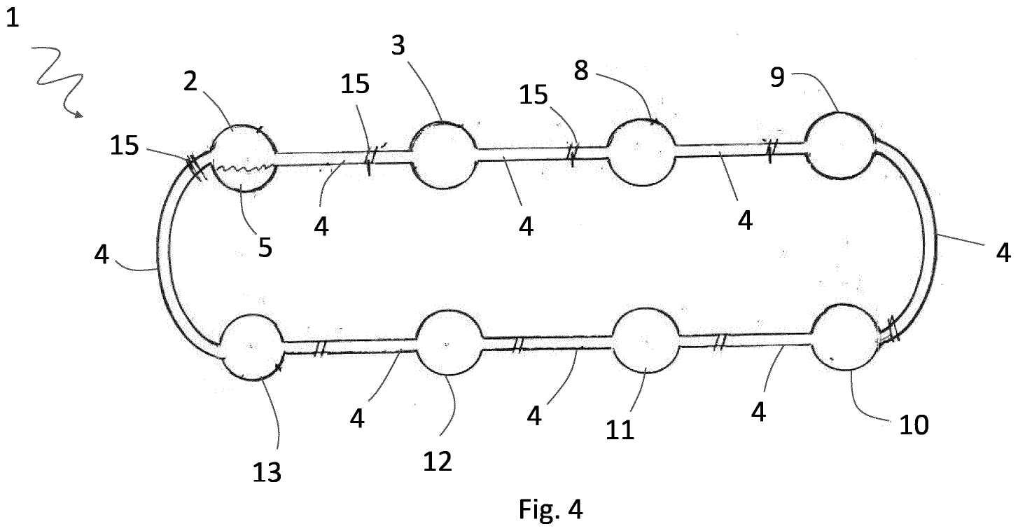

FIG. 4 shows a variation of the embodiment of FIG. 3 wherein multiple chambers are arranged in a closed-circuit configuration. As in FIG. 2, by heating the chambers in the appropriate sequence, the liquid 5 can circulate continuously in the assembly.

It has to be noted that FIG. 4 illustrates one duct 4 to connect each pair of adjacent chambers, however in other embodiments more than one duct may be provided between adjacent chambers.

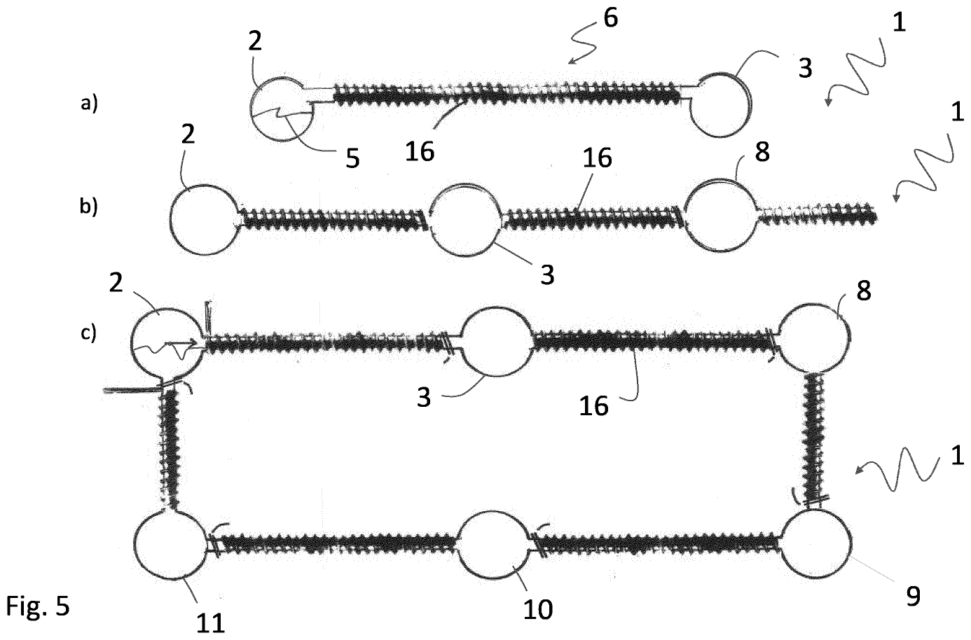

FIG. 5 illustrates embodiments a), b) or c) wherein the communication ducts 4 are wrapped with solenoids 16. Said solenoids 16 can generate electric power due to their interaction with rotating and/or travelling magnetic elements inside the ducts 4. It should be noted that power is transferred from inside to the outside of the assembly via the interaction between the travelling or rotating magnets and the coils or solenoids.

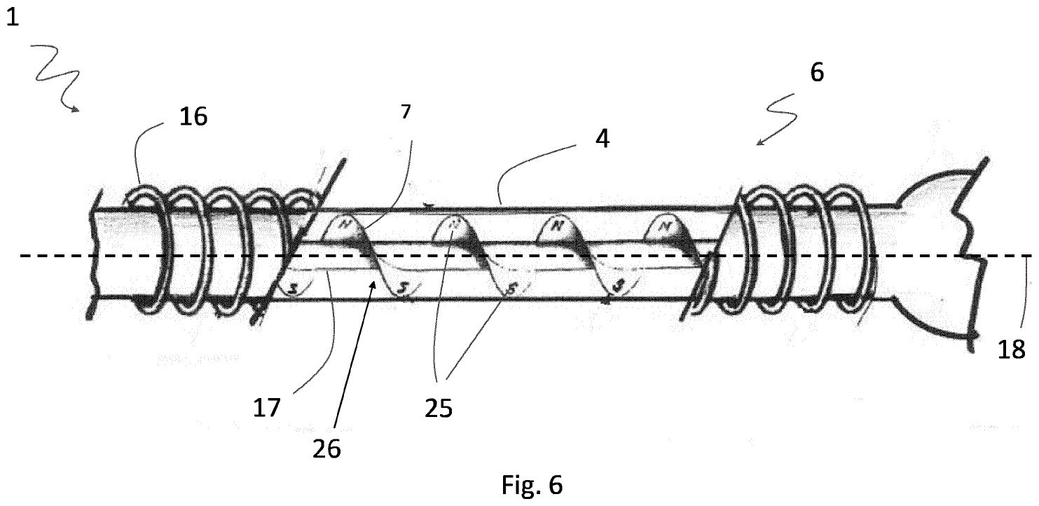

FIG. 6 illustrates a preferred embodiment of an energy conversion device 6 arranged in/on a duct 4.

The energy conversion device 6 in this embodiment includes a solenoid 16 inductively coupled with a rotating magnetic element 7 including helix shaped blades 26 supported by a bar 17. Said bar 17 may be either a rotating bar or a stationary bar.

Each blade 26 has magnetic poles 25 and can either be integral with the rotating bar 17 or rotate around the same bar. The bar 17 is provided with an axis parallel to a longitudinal axis 18 of the communication duct 4.

A rotation of the magnetic element 7 relative to the solenoid 16 is induced by the thrust of the working medium 5 when is displaced from one chamber to another chamber. Said rotation of the rotating magnetic element 7, and therefore a rotation of its magnetic poles 25, induces an electric current in the solenoid 16.

It should be noted that thanks to the inductive coupling, power is transferred from the magnetic element 7 inside the duct 4 to the solenoid 16 outside the duct in a contactless manner without the need of connection means passing through the duct.

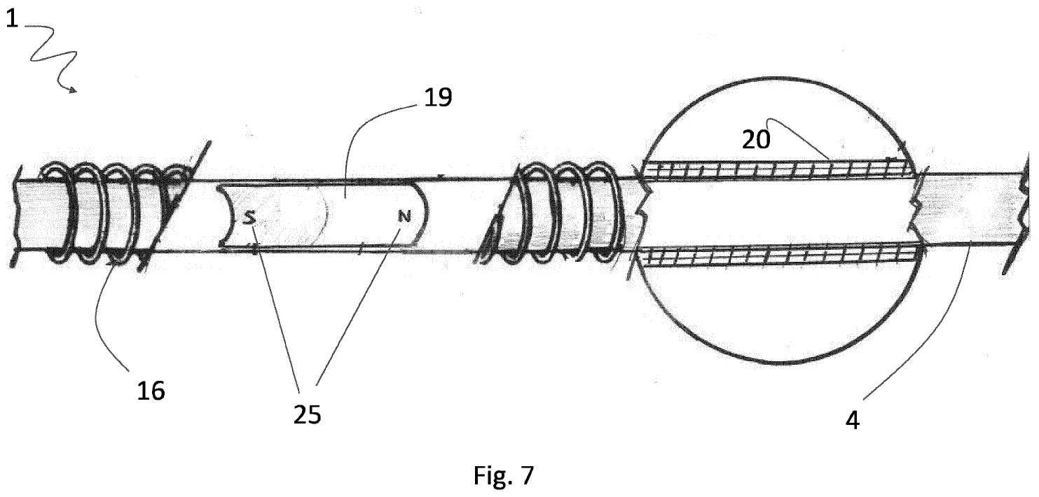

FIG. 7 shows an alternative embodiment, wherein the magnetic elements are displaceable magnetic elements 19.

The displaceable magnetic elements 19 are arranged to travel through the assembly, for example between chambers and through connecting ducts. Accordingly, electric power is induced by the displacement of said elements 19.

In figure, it can be noted that the apparatus includes a grid casing 20 arranged in a chamber to guide said displaceable magnet elements 19 when travelling through the chamber and prevents said magnet 19 from falling into said chamber. When multiple chambers are provided, each chamber of the apparatus may be provided with a respective grid casing 20.

1-24. (canceled)

25. An apparatus for generation of electric power comprising:
a sealed assembly including at least two chambers and a communication duct, wherein the communication duct is arranged to provide fluid communication between said two chambers;
a working medium in a liquid state contained in at least one of said chambers;
wherein a vacuum condition is provided in the assembly, so that the boiling temperature of said liquid working medium in the assembly is lower than the boiling temperature of the same liquid at ambient pressure;
wherein the volume of said liquid working medium is less than the inner capacity of the whole assembly;
wherein the apparatus is configured in such a way that heating the liquid working medium contained in a first chamber of the assembly induces a transfer of the working medium, either in liquid state or in a vapor state, from said first chamber to a second chamber of the assembly, through a communication duct between said first chamber and second chamber;
the apparatus further comprising at least one energy conversion device (6) arranged in at least one of said chambers and/or in the communication duct and configured to transform energy of the working medium travelling through the apparatus into an electric power output,
wherein said energy conversion device includes at least one magnetic element, said at least one magnetic element being arranged to enter into direct contact with the working medium, and
wherein said assembly includes more than two chambers forming a sequence of chambers, and wherein the working medium is transferred through the chambers by means of a plurality of transfer steps, each step being a transfer from a first chamber to a second chamber next to the first chamber in the sequence, the transfer of the working medium being operated as a result of heating any of the chambers of the apparatus, wherein the sequence of chambers forms a closed circuit and the process is performed cyclically while the working medium traverses the closed-circuit sequence of chambers.

26. The apparatus according to claim 25, wherein said liquid working medium is a pure liquid or a liquid mixture and has a boiling point lower than the boiling point of water.

27. The apparatus according to claim 25, wherein said assembly is configured so that one or more of the communication ducts act as connecting elements and/or supporting elements for two or more of the chambers.

28. The apparatus according to claim 25, wherein the assembly is configured so that the working medium effluent from said first chamber through a communication duct returns in the same first chamber either through the same communication duct or through a separate communication duct.

29. The apparatus according to claim 25, wherein one or more barriers are provided in connection with the chambers and/or with the communication ducts, said barriers being driven to prevent a backflow of the working medium from one chamber to a preceding chamber.

30. The apparatus according to claim 25, wherein said energy conversion device includes at least one rotating magnetic element or displaceable magnetic element, and at least one coil or solenoid inductively coupled with the magnetic element, arranged so that a rotation or displacement of the magnetic element induces an electric current in the coil or solenoid.

31. The apparatus according to claim 25, wherein said energy conversion device includes at least one rotating magnetic element which is arranged to rotate under the thrust of said working medium when said working medium is displaced from one chamber to another chamber.

32. The apparatus according to claim 31, wherein said rotating magnetic element is supported by a bar, said bar being preferably inside a communication duct, wherein the axis of said bar is preferably parallel to a longitudinal axis of said communication duct, wherein either said bar is a rotating bar dragged by said rotating elements under the thrust of said working medium, or said bar is a stationary bar while said rotating elements rotate around said bar.

33. The apparatus according to claim 32, including a plurality of rotating bars to support rotating magnetic elements and wherein at least one first rotating bar is connected to one or more second rotating bar(s) in such a way to increase the rotational speed of said one or more second rotating bar(s).

34. The apparatus according to claim 32, wherein:
a coil or solenoid is located in a position adjacent and preferably wrapped onto an enclosure within which the rotating magnetic element is disposed to rotate, or
a coil or solenoid constitutes itself an enclosure within which said rotating magnetic element is disposed to rotate, so that the rotation of the rotating magnetic element produces an electric current in the coil or solenoid.

35. The apparatus according to claim 25, wherein said energy conversion device includes at least one displaceable magnet arranged to be displaced by the working medium from one chamber to another through a communication duct, further including at least one device, preferably in the form of a grid casing, arranged in a chamber to guide said displaceable magnet when travelling through the chamber and prevent said magnet from falling into the chamber.

36. The apparatus according to claim 35, including a plurality of displaceable magnets joined together, possibly with spacer elements between them, to form a single displaceable element.

37. The apparatus according to claim 35, wherein displaceable magnets are arranged so that, when travelling through the device, each pole of a magnet faces a pole of a preceding or following magnet of the same polarity.

38. The apparatus according to claim 25, wherein said energy conversion device includes at least one coil or solenoid and at least one magnetic element arranged to rotate or move relative to the coil or solenoid, thus providing a variable magnetic field in the coil or solenoid and an induced electromotive force

39. The apparatus according to claim 25, wherein said magnetic elements include permanent magnets.

40. The apparatus according to claim 25, wherein said communication duct(s) is/are made of an electrically conductive metal.

41. The apparatus according to claim 25, including at least one communication duct wherein a coil or solenoid is wrapped around said duct, or a coil or solenoid constitutes said communication duct.

42. The apparatus according to claim 25, comprising a plurality of coils or solenoids, wherein at least some of the coils or solenoids are electrically connected to each other.

43. The apparatus according to claim 25, including a combination of rotatable magnetic elements and displaceable magnets.

44. A process for the production of electric power comprising the steps of:
providing an apparatus with a sealed assembly according to claim 25;
providing a working medium in a liquid state contained in at least one of the chambers of said sealed assembly;
forming a vacuum condition in the assembly, so that the boiling temperature of said liquid working medium in the assembly is lower than the boiling temperature of the same liquid at ambient pressure;
heating the liquid working medium contained in a first chamber of the assembly so to induce a transfer of the working medium from said first chamber to a second chamber of the assembly, through a communication duct between said first chamber and second chamber;
transforming energy of the working medium travelling through the apparatus into a power output by means of at least one energy conversion device arranged in at least one of said chambers and/or in the communication duct, wherein said device includes at least one magnetic element arranged to enter into direct contact with the working medium; and
wherein the working medium is transferred from said first chamber to said second chamber in a liquid state or in a gaseous state.

45. The process according to claim 44 wherein, during the process, the working medium has a temperature below the Curie point of any magnetic element of the energy conversion device to avoid de-magnetization.
